(19) United States
(12) Patent Application Publication
(10) Pub. No.: US 2014/0318706 A1
(43) Pub. Date: Oct. 30, 2014

(54) METHOD TO ALIGN COVERS ON STRUCTURED LAYERS AND RESULTING DEVICES

(71) Applicant: Corning Incorporated, Corning, NY (US)

(72) Inventor: Stephane Poissy, Brunoy (FR)

(21) Appl. No.: 14/361,383

(22) PCT Filed: Nov. 28, 2012
(86) PCT No.: PCT/US12/66722

§ 371 Date: May 29, 2014

Related U.S. Application Data
(60) Provisional application No. 61/565,013, filed on Nov. 30, 2011.

(51) Int. Cl. B32B 37/18

(52) U.S. Cl. CPC B32B 37/18
USPC 156/308.2

(57) ABSTRACT

A method for forming a fluidic module for a continuous flow reactor includes providing at least one planar glass or ceramic sheet having one or more through-holes, forming at least one patterned glass or ceramic layer having at least one patterned surface such that the patterned surface comprises channels defined between walls having an upper surface at a common height, stacking the at least one glass or ceramic sheet and the at least one patterned glass or ceramic layer together, the sheet contacting the walls at the common height, such that the channels are enclosed between the sheet and the patterned layer, the sheet being aligned with the patterned layer such that the one or more through-holes each align with respective spaces between walls of the patterned layer to provide fluid access to said respective spaces, and joining the sheet and the patterned layer together by pressing the sheet and the patterned layer together while heating the sheet and the patterned layer; wherein the patterned glass or ceramic layer further comprises one or more raised structures extending above the common height, and wherein the step of stacking comprises stacking the sheet on the upper surface of the walls at the common height, in a position such that the one or more raised structures confine the sheet to a desired position or alignment on the patterned layer.

This application claims the benefit of priority under 35 USC §119 of U.S. Provisional Application Ser. No. 61/565013 filed on Nov. 30, 2011 the content of which is relied upon and incorporated herein by reference in its entirety.

### FIELD

The present disclosure relates generally to methods for forming mcirofluidic modules and particularly to methods for aligning covers on structured layers of microfluidic modules and to the resulting devices.

### BACKGROUND AND SUMMARY

Microreactors, or continuous flow reactors having channels micrometer- up to tens of millimeter-scale minimum dimensions, offer many advantages over conventional batch reactors, including very significant improvements in energy efficiency, reaction condition control, safety, reliability, productivity, scalability, and portability. In such a microreactor, the chemical reactions take place continuously, generally in confinement within such channels, hence the term “continuous flow reactor.” Microreactors can be built up from microfluidic modules that perform one or more specific functions, such as mixing, dwell time (to allow a a reaction or other process to go to completion), separation, and so forth.

According to one embodiment of the disclosure, a method for forming a fluidic module for a continuous flow reactor includes providing at least one planar glass or ceramic sheet having one or more through-holes, forming at least one patterned glass or ceramic layer having at least one patterned surface such that the patterned surface comprises channels defined between walls having an upper surface at a common height, stacking the at least one glass or ceramic sheet and the at least one patterned glass or ceramic layer together, the sheet contacting the walls at the common height, such that the channels are enclosed between the sheet and the patterned layer, the sheet being aligned with the patterned layer such that the one or more through-holes each align with respective spaces between walls of the patterned layer to provide fluid access to said respective spaces, and joining the sheet and the patterned layer together by pressing the sheet and the patterned layer together while heating the sheet and the patterned layer; wherein the patterned glass or ceramic layer further comprises one or more raised structures extending above the common height, and wherein the step of stacking comprises stacking the sheet on the upper surface of the walls at the common height, in a position such that the one or more raised structures confine the sheet to a desired position or alignment on the patterned layer.

Certain variations and embodiments of the method of the present disclosure are described in the text below and with reference to the figures, described in brief immediately below.

### BRIEF DESCRIPTION OF THE DRAWINGS

The following detailed description of specific embodiments of the present disclosure can be best understood when read in conjunction with the following drawings, where like structure is indicated with like reference numerals and in which:

FIGS. 1 and 2 show a elevational cross sectional view of prior art arrangement of covers on structured layers being assembled to form a microfluidic module;

FIG. 3 is an elevational cross sectional view an arrangement of a cover on a structured layer according to an embodiment of the present disclosure;

FIG. 4 is a plan view of an arrangement of a cover on a structured layer according of the embodiment of FIG. 3;

FIG. 5 is an elevational cross sectional view an arrangement of a cover on a structured layer according to another embodiment of the present disclosure; and

FIGS. 6-9 are plan views of various alternative versions of arrangements of cover layers on structured layers of the embodiment of FIG. 5.

### DETAILED DESCRIPTION

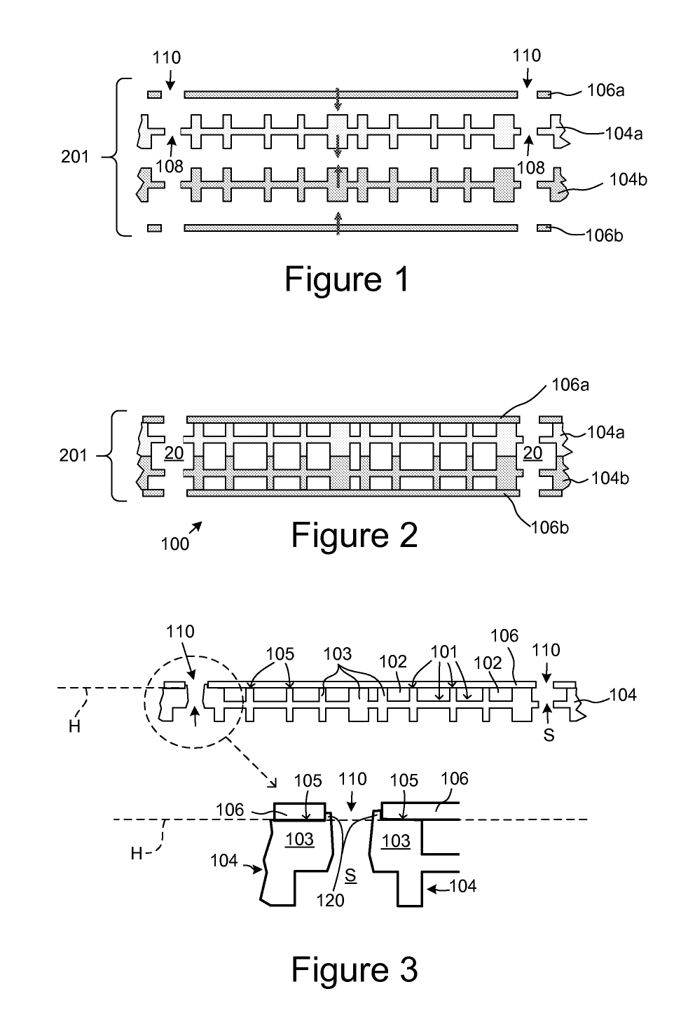

As seen in FIGS. 1 and 2, In previous work by the present inventor(s) and/or colleagues of the present inventor(s), fluidic modules 100 for microreactors (flow reactors with sub-millimeter to 10's of millimeter scale channels, assembled from multiple modules) are typically formed as an assembly 102 of two structured layers 104a, 104b and two flat covers 106a, 106b, which are then sealed together under high temperature. The structured layers 104a, 104b are replicated from a specifically designed mold.

The two structured layers 104a, 104b can easily be aligned to teach other thanks to a mortise and tenon type structure (not shown) that be desirably formed on facing surfaces of the two structured layers 104a, 104b.

One way covers have been aligned is by visual inspection, with aligned covers glued into place. But once the fluidic module parts are assembled together, the stack of them is sealed under high temperature, at much higher temperatures than the glue can withstand. If some vibration is generated in the firing oven, good alignment may be lost. When covers are not well aligned, cover holes 110 are not in front of the holes 108 of the structured layers 104a, 104b, and may generate additional pressure drop when a fluid passes through these holes or the “ports” 20 formed by the joining of these holes. Further, glue may also generate pollution in the module during the firing process.

According to the present disclosure, a method is provided for forming a fluidic module for a continuous flow reactor, with the method comprising the steps of (1) providing at least one planar glass or ceramic sheet having one or more through-holes; (2) forming at least one patterned glass or ceramic layer having at least one patterned surface such that the patterned surface comprises channels defined between walls having an upper surface at a common height; (3) stacking the at least one glass or ceramic sheet and the at least one patterned glass or ceramic layer together, the sheet contacting the walls at the common height, such that the channels are enclosed between the sheet and the patterned layer, the sheet being aligned with the patterned layer such that the one or more through-holes each align with respective spaces between walls of the patterned layer to provide fluid access to said respective spaces; and (4) joining the sheet and the patterned layer together by pressing the sheet and the patterned layer together while heating the sheet and the patterned layer, wherein the patterned glass or ceramic layer further comprises one or more raised structures extending above the common height, and wherein the step of stacking comprises stacking the sheet on the upper surface of the walls at the common height, in a position such that the one or more raised structures confine the sheet to a desired position or alignment on the patterned layer. This method will be more closely described below with reference to specific variations thereof illustrated in FIGS. 3-9.

3. The method according to claim 1, wherein the sheet 106 has at least two through-holes 110, and wherein the one or more raised structures 120 are positioned within at least two of the at least two through-holes 110. In the cross-section of FIG. 3, only one such through-hole is visible, the one on the left of the Figure.

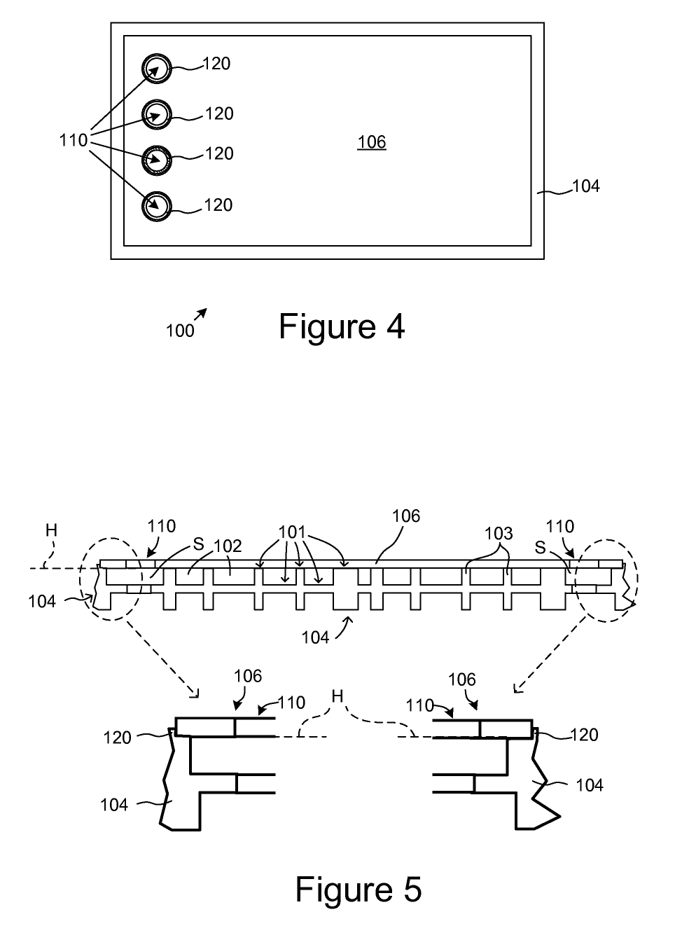

FIG. 4 is a plan view of an arrangement of a cover on a structured layer according of the embodiment of FIG. 3, wherein each of four through-holes 110 in the sheet 106 includes a raised structure 120 positioned within said through-hole 110. (One of the raised structures 120 is shaded for viewing clarity.) Desirably, at least two of the holes have such raised structures 120, so that together they can determine the alignment, both position and angle, of the sheet 106 as it rests on structured layer 104. In this embodiment, the raised structures also take the form of a continuous rim 110 surrounding the inside of the through holes 110.

FIG. 5 shows a cross section of a cover in the form of a sheet 106 on a structured layer 104 according to another embodiment of the present disclosure, wherein one or more raised structures 120 take the form of raised structures positioned at the outermost edges of the sheet 106.

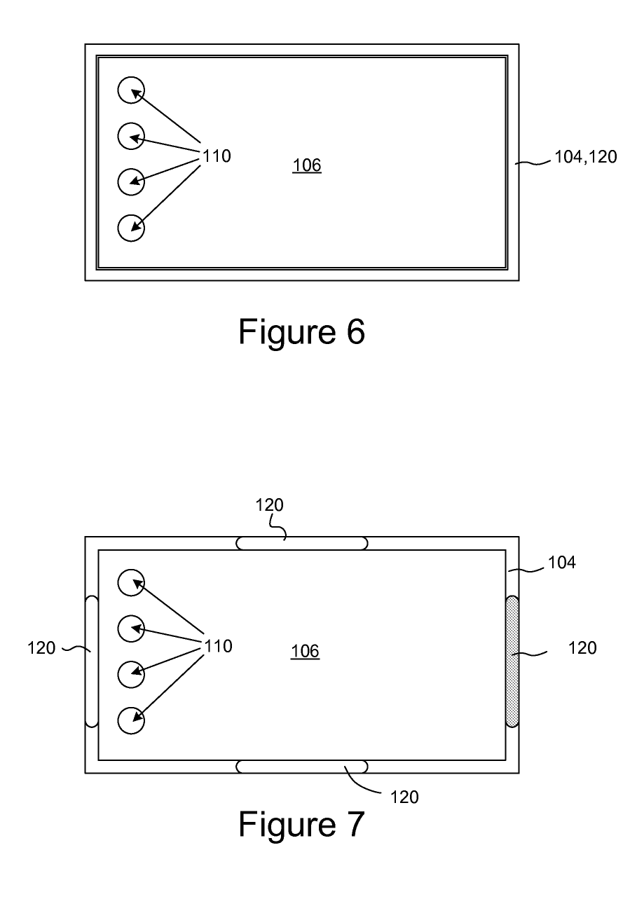

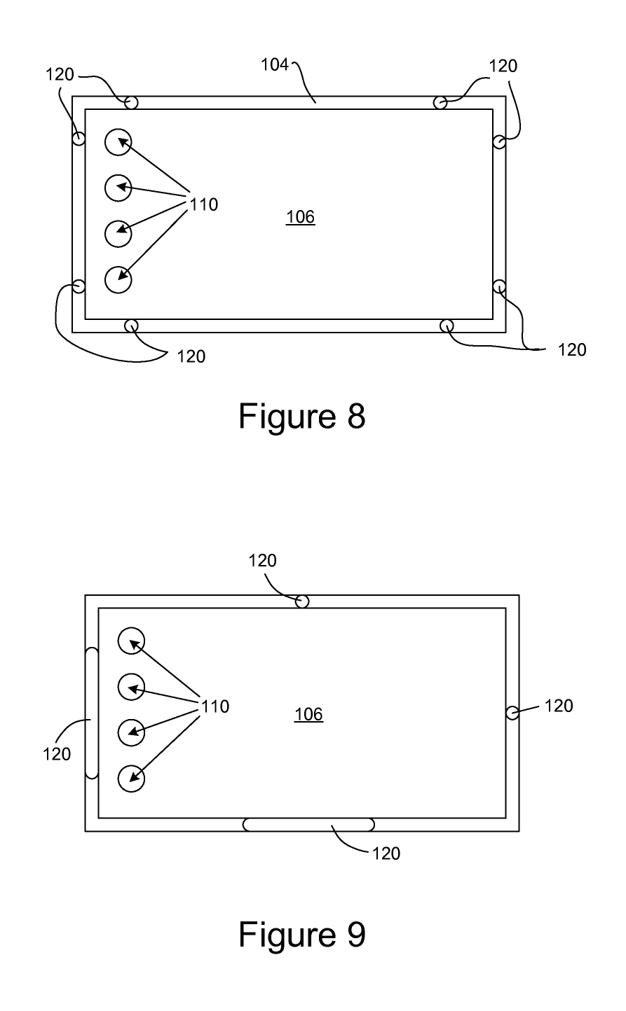

FIGS. 6-9 are plan views of various alternative versions of arrangements of cover layers on structured layers of the embodiment of FIG. 5. In FIG. 6, the one or more raised structures 120 comprises a continuous rim 120 surrounding the sheet 106. In FIG. 7, the one or more raised structures 120 comprise a discontinuous rim or discrete portions of a rim surrounding the sheet 106, one discrete portion of which is shaded for easier identification. In FIG. 8, the one or more raised structures 120 take the form of one or more posts 120. In the embodiment of FIG. 9, a combination of broken and posts is used for raised structures 120.

The methods disclosed herein and the devices produced thereby are generally useful in performing any process that involves mixing, separation, extraction, crystallization, precipitation, or otherwise processing fluids or mixtures of fluids, including multiphase mixtures of fluids—and including fluids or mixtures of fluids including multiphase mixtures of fluids that also contain solids—within a microstructure. The processing may include a physical process, a chemical reaction defined as a process that results in the interconversion of organic, inorganic, or both organic and inorganic species, a biochemical process, or any other form of processing. The following non-limiting list of reactions may be performed with the disclosed methods and/or devices: oxidation; reduction; substitution; elimination; addition; ligand exchange; metal exchange; and ion exchange. More specifically, reactions of any of the following non-limiting list may be performed with the disclosed methods and/or devices: polymerisation; alkylation; dealkylation; nitration; peroxidation; sulfoxidation; epoxidation; ammoxidation; hydrogenation; dehydrogenation; organometallic reactions; precious metal chemistry/ homogeneous catalyst reactions; carbonylation; thiocarbonylation; alkoxylation; halogenation; dehydrohalogenation; dehalogenation; hydroformylation; carboxylation; decarboxylation; amination; arylation; peptide coupling; aldol condensation; cyclocondensation; dehydrocyclization; esterification; amidation; heterocyclic synthesis; dehydration; alcoholysis; hydrolysis; ammonolysis; etherification; enzymatic synthesis; ketalization; saponification; isomerisation; quaternization; formylation; phase transfer reactions; silylations; nitrile synthesis; phosphorylation; ozonolysis; azide chemistry; metathesis; hydrosilylation; coupling reactions; and enzymatic reactions.

It is noted that terms like “preferably,” “commonly,” and “typically,” when utilized herein, are not utilized to limit the scope of the claimed invention or to imply that certain features are critical, essential, or even important to the structure or function of the claimed invention. Rather, these terms are merely intended to identify particular aspects of an embodiment of the present disclosure or to emphasize alternative or additional features that may or may not be utilized in a particular embodiment of the present disclosure.

Having described the subject matter of the present disclosure in detail and by reference to specific embodiments thereof, it will be apparent that modifications and variations are possible without departing from the scope of the invention defined in the appended claims. More specifically, although some aspects of the present disclosure are identified herein as preferred or particularly advantageous, it is contemplated that the present disclosure is not necessarily limited to these aspects.

It is noted that one or more of the following claims utilize the term “wherein” as a transitional phrase. For the purposes of defining the present invention, it is noted that this term is introduced in the claims as an open-ended transitional phrase that is used to introduce a recitation of a series of characteristics of the structure and should be interpreted in like manner as the more commonly used open-ended preamble term “comprising.”

1. A method for forming a fluidic module for a continuous flow reactor, the method comprising:
providing at least one planar glass or ceramic sheet having one or more through-holes; forming at least one patterned glass or ceramic layer having at least one patterned surface such that the patterned surface comprises channels defined between walls having an upper surface at a common height;
stacking the at least one glass or ceramic sheet and the at least one patterned glass or ceramic layer together, the sheet contacting the walls at the common height, such that the channels are enclosed between the sheet and the patterned layer, the sheet being aligned with the patterned layer such that the one or more through-holes each align with respective spaces between walls of the patterned layer to provide fluid access to said respective spaces; and joining the sheet and the patterned layer together by pressing the sheet and the patterned layer together while heating the sheet and the patterned layer;
wherein the patterned glass or ceramic layer further comprises one or more raised structures extending above the common height, and
wherein the step of stacking comprises stacking the sheet on the upper surface of the walls at the common height, in a position such that the one or more raised structures confine the sheet to a desired position or alignment on the patterned layer.

2. The method according to claim 1, wherein the one or more raised structures are positioned at the outermost edges of the sheet.

3. The method according to claim 1, wherein the sheet has at least two through-holes, and wherein the one or more raised structures are positioned within at least two of the at least two through-holes.

4. The method according to claim 2 wherein the one or more raised structures comprise a continuous rim surrounding the sheet or a rim surrounding a through-hole in the sheet.

5. The method according to claim 2 wherein the one or more raised structures comprise a discontinuous rim or discrete portions of a rim surrounding the sheet or surrounding a through-hole in the sheet.

6. The method according to claim 2 wherein the one or more raised structures comprise posts on the patterned layer, said posts extending above the common height.
